(19) United States
(12) Patent Application Publication
(10) Pub. No.: US 2022/0188065 A1
(43) Pub. Date: Jun. 16, 2022

(54) WIRELESS AUDIO DEVICE, SYSTEM AND METHOD

(71) Applicant: Ingenious Audio Limited

(72) Inventor: John Crawford, Edinburgh (GB)

(73) Assignee: Ingenious Audio Limited, Daejeon (KR)

(21) Appl. No.: 17/549,135

(22) Filed: Dec. 13, 2021

(30) Foreign Application Priority Data
Dec. 13, 2020 (GB) GB2019640.8

(51) Int. Cl. G06F 3/16; H04B 1/04; H04B 5/02; H04N 21/4363

(52) U.S. Cl. CPC G06F 3/165; H04B 1/04; H04W 4/80; H04N 21/43635; H04B 5/02

(57) ABSTRACT

A transmitter device comprises a connector configured to connect to an audio or audio/visual device, processing circuitry configured to receive an HDMI digital data stream from the audio or audio/visual device and obtain a digital audio stream from the digital data stream, and a transmitter arrangement configured to transmit wirelessly the digital audio stream as Wi-Fi packets and/or wireless internet data to a receiver device for output of sound.

### PRIORITY

This Application claims priority to United Kingdom Patent Application No. GB 2019640.8, dated Dec. 13, 2020 which is incorporated herein by reference in its entirety.

### FIELD

The present invention relates to a wireless audio device, system and method, for example to enable output of audio obtained from a High-Definition Multimedia Interface (HDMI) data stream.

### BACKGROUND

In existing HDMI signal-generating devices, digital audio and video data is output to wired HDMI connector jack plug or jack socket connections, and transmitted over an HDMI cable.

Physical cables have limitations in terms of physical range and electrical and mechanical issues relating to the cable, including electrical impedance and resistance.

In many cases it is beneficial to have the sound generating device at a distance from the HDMI signal generating or HDMI signal receiving device, for example headphones in communication with a TV screen or display.

Over such distances cables are cumbersome and a physical restriction.

In many cases it is beneficial to have multiple sound generating devices at distance from the HDMI signal generating or HDMI signal receiving device, for example multiple 5.1 or 7.1 speakers in communication with a TV screen or display.

Making physical cable connections to each signal receiving device is both cumbersome and complex.

To overcome the limitations of the physical cables, devices exist today which convert the audio and visual signal from a HDMI signal-generating device into a digital audio and visual signal for transmission by radio (Bluetooth/2.4G/FM/AM/UHF/VHF).

Known systems often use conventional radio transmission systems such as FM, AM, UHF and VHF which are subject to electromagnetic interference.

Some known systems send both the HDMI audio and video as a combined signal, typically for reception into a home theatre system or television. However, by sending both audio and video the amount of data being sent is large and consequently the signal bandwidth is very high.

Many known systems are unsecure (due to the relative ease of a radio signal being intercepted by a third party).

Known systems also exist for transmitting audio over Bluetooth. Bluetooth has a number of restrictions in terms of transmission delay, meaning that in television applications lip-sync issues can be observed, and audio quality and transmission range can be unsatisfactory.

Some known systems typically require a dedicated transmitter device and a dedicated receiver device.

Many known systems operate in slower-than real time. As the audio and video data are being sent together, the combined signal is decoded on reception, meaning that the transmission delay is applied to both audio and video. This can lead to a delay to both signals making activities like gaming difficult. Alternatively, audio may be sent via Bluetooth, with associated delays, and corresponding video is displayed on a screen, causing lip-sync or other synchronisation or mismatch issues between the audio and video.

U.S. Pat. No. 9,699,578, the contents of which are hereby incorporated by reference, describes a system for transmitting real time digital audio over Wi-Fi from analog signal generating devices. Such applications are for use with analog signal generating devices such as guitars, and cannot connect to digital audio and video sources such as HDMI.

Devices such as network media centres and wireless base stations which receive digital audio data by means of WLAN Internet (for example transmitting data from a personal computer to a wireless networking device) are known. Such devices function as receiver only and require a digital server system, typically a personal computer.

There are various known systems and standards for wirelessly sending non-real time compressed audio over the internet, such as iTunes, internet radio etc. Known systems are generally not optimised for carrying audio unless it is compressed or subject to delay. These systems typically involve the transmitting partner to be separate from the receiver, and therefore, in these settings, is tolerant to delay. i.e. if the “live” radio channel that is being listened to is in fact 300 msec delayed, the user is generally not affected, and related content from the same source is subject to the same delay. In contrast, in local settings delay may be unacceptable. If the audio stream from a TV is delayed relative to the image lip sync issues can be observed, for example.

### SUMMARY

In a first aspect, which may be provided independently, there is provided a transmitter device comprising:
a connector configured to connect to an audio or audio/visual device;
processing circuitry configured to receive a digital data stream from the audio or audio/visual device and to obtain a digital audio stream from the digital data stream;
a transmitter arrangement configured to transmit wirelessly the digital audio stream as packets, for example Wi-Fi packets, and/or wireless internet data to a receiver device for output of sound.

The device may comprise a receiver connected to or forming part of the processing circuitry and configured to receive the digital data stream via the connector from the audio or audio/visual device. The receiver may comprise an HDMI receiver or an HDMI transceiver.

The device may be configured to transmit the digital audio stream so as to provide for simultaneous output of the transmitted audio stream as sound and output of corresponding video of the digital data stream by the audio or audio/visual device. The receiver may be arranged to receive the digital data stream via a wired or other physical connection between the connector and the receiver.

The connector may comprise a jack plug or jack socket, for example an HDMI jack plug or HDMI jack socket. The connector may comprise any suitable HDMI connector. The audio or audio/visual device may comprise an HDMI signal generating device. The digital data stream may comprise HDMI data. The transmitter arrangement may comprise or form part of a wireless internet transceiver system. The processing circuitry may comprise a Media Access Controller.

The HDMI data or HDMI connector may comprise data or a connector in accordance with any suitable HDMI version or protocol, for example any one or more of HDMI version 1.0, version 1.1, version 1.2, version 1.3, version 1.4, version 2.0, version 2.1 data and any other past, present or future version of HDMI.

The packets and/or wireless internet data may comprise data according to an 802.11 protocol, for example any one of an 802.11-1997, 802.11a, 802.11b, 802.11g, 802.11-2007, 802.11n, 802.11-2012, 802.11ac, 802.11ad, 802.11af, 802.11-2016, 802.11ah, 802.11ai, 802.11aj, 802.11aq, 802.11-2020, 802.11ax, 802.11ay protocol or any other 802.11 protocol.

The packets and/or wireless internet data may be transmitted using UDP or TCP protocol.

The transmitter device may be configured to establish a wireless network with a plurality of receiver devices, and to transmit the digital audio stream to a selected at least one of the devices.

The audio or audio/visual device may comprise at least one of a personal computer, a television set, a cable or satellite set top box, a MP3 docking station, a mobile telephone, a video games system or a DVD player, or a device connected thereto.

The transmitter device may be further configured to transmit the digital data stream, or at least a video component of the digital data stream, to a further receiver device for output of video; and/or
the transmitter device may be further configured to relay the original data stream to another device via physical and/or wired connection and/or via a wireless connection.

The processing circuitry may comprise a baseband processor and/or the transmitter may further comprise a wireless internet radio for transmitting the digital data stream or at least a video component of the digital data stream.

The device may comprise at least one of:
a) an electrical switch to power the device on or off; or
b) an electrical circuit to configure the device into transmit or receive mode; or
c) a circuit or system to process S/PDIF audio; or
d) an electrical circuit and/or a software program to configure the device as a member of a wireless network; or
e) a battery or wired power supply.

The transmitter device may be configured to receive configuration and/or control data from a mobile telephone or other remote device, and/or from a user.

The transmitter device may be configured to, in response to the configuration and/or control data, establish a wireless network, and/or change network configuration, and/or establish or cease connection between the device and the or a receiver device, and/or control to which receiver device audio data is transmitted.

The transmitter device may be configured to apply audio error correction to the audio data, optionally software audio error correction using finite impulse response (FIR) or fast Fourier transform(FFT) techniques.

In a further aspect, which may be provided independently, there is provided a receiver device configured to receive digital audio data from a transmitter device, for example a transmitter device as claimed or described herein, wherein the receiver device comprises:
a receiver arrangement for receiving packets and/or wireless internet data; and
processing circuitry configured to obtain the digital audio data from the packets and/or wireless internet data, for providing to a speaker device to generate sound.

The receiver arrangement may comprise a wireless internet transceiver and the processing circuitry may comprise a Media Access Controller.

The processing circuitry may comprise a baseband processor and/or the receiver device may comprise a wireless internet radio. The receiver device may comprise an audio codec. The receiver device may comprise, or be connectable to, an amplifier, for example a headphone or speaker amplifier. The receiver device may be included in, connected to, or connectable to a speaker, headphone or amplifier.

The receiver device may further comprise a buffer for received audio data.

The receiver device may further comprise at least one of:
a) an electrical switch to power the device on or off; or
b) an electrical circuit to configure the device into transmit or receive mode; or
c) a circuit or system to process S/PDIF audio; or
d) an electrical circuit and/or a software program to configure the device as a member of a wireless network; or
e) a battery or wired power supply.

The receiver device may be configured to receive configuration and/or control data from a mobile telephone or other remote device, and/or from a user.

The receiver device may be configured to, in response to the configuration and/or control data, establish a wireless network, and/or change network configuration, and/or establish or cease connection between the receiver device and the or a transmitter device, and/or control from which transmitter device audio data is received.

The processing circuitry may be configured to apply a delay to the received data or to filter the received data.

In a further aspect, there is provided a wireless audio system comprising a transmitter device as claimed or described herein, and a receiver device as claimed or described herein. The system may comprises a plurality of the receiver devices and/or a plurality of the transmitter devices.

The receiver device and/or the transmitter may further incorporate a Bluetooth wireless network system to enable communication via Bluetooth between the receiver device and/or the transmitter device and/or at least one further device.

The system may further comprise the audio or audio/visual device. The audio or audio/visual device may be capable of externally receiving and/or internally generating the digital data stream, and/or is configured to obtain the digital data stream from any one of a plurality of sources.

The system may further comprise a wireless networking point, and/or a signal booster and/or other device configured to relay and/or amplify the digital audio stream from the transmitter device for onward transmission to the receiver device.

The transmitter device may comprise a housing. All components of the transmitter device may be within, or extending from, the housing. The receiver device may comprise a housing. All components of the receiver device may be within, or extending from, the housing of the receiver device.

In a further aspect, which may be provided independently, there is provided a method of providing audio data to a remote device comprising:
extracting digital audio data from a digital data stream from an audio or audio/visual device and transmitting wirelessly the digital audio data as packets and/or wireless internet data to the remote device for output of sound.

In a further aspect, there is provided a method of adapting an existing audio or audio/visual device, for example an HDMI device, for transmission of wireless internet audio data by connecting a transmitter device as claimed or described herein.

According to an aspect, which may be provided independently, there is provided an electronic system for transmitting low-latency audio data from a HDMI signal-generating device across a wireless internet link, for example a wireless local area network (WLAN), and for the reception of a signal, for example representing the data, for example a WLAN signal, and conversion of the signal into audio data for output via a speaker.

According to an aspect, which may be provided independently, there is provided a transmitter device in communication with one or many instances of a receiver device. The transmitter device may use a standard HDMI connector plug or plug socket to connect to a HDMI signal-generating device and convert the HDMI data into digital audio data within wireless internet format and enable WLAN transmission of the signal to the receiver device. This may ensure the reception and re-conversion of said audio signal into sound. In some cases the receiver device will be integrated into a sound generating device.

Examples of HDMI signal-generating devices include televisions, video game systems, personal computers and the like.

Examples of sound generating devices include TV speakers, subwoofers and headphones.

Some devices, such as at least some televisions, may be both HDMI signal-generating and HDMI signal-receiving devices.

According to an aspect, which may be provided independently, there is provided a wireless audio system comprising a wireless internet transmitter device, an HDMI jack plug, an HMDI transceiver and a wireless internet transceiver. The wireless internet transceiver may be configured to transmit audio data by wireless internet to a wireless internet receiver device. The receiver device may comprise a wireless internet transceiver, a microprocessor and an audio circuit.

The transmitter device may be configured to establish a wifi or other network for other devices to connect to.

The device or system may be configured to use Wi-Fi standards which include coding techniques, for example orthogonal frequency-division multiplexing (OFDM) in IEEE 802.11a and 802.11g, which both increase the maximum data rate and greatly reduce interference by splitting the radio signal into several sub-signals before they reach the receiver.

The device may be configured to extract data from an audio channel allowing multiple channels of audio to be sent over a link in real time in lower bandwidth. Low delay audio may be sent to individual receivers. Receiver devices that do not require video support can be less complex and easier to manufacture.

Use of a WLAN may provide easily configurable one-to-many and many-to-many connections. Possible uses of this feature include, multi-channel home audio, where there are 5.1 or 7.1 speakers in the room.

The use of wireless internet can allow the device to easily connect to a range of existing and future WLAN capable devices for example including personal computers and wireless internet routers.

This can allow capabilities such as re-configuring the network, for example to add new speakers, or manage different audio streams on different devices.

The use of WLAN can provide a convenient method to network multiple devices together and integrates security features such as Wi-Fi Protected Access (WPA) encryption, ensuring only the intended recipients of the data can decode the signal.

The device or system may allow an existing HDMI signal-generating device (e.g. such as a television) to be connected by WLAN Internet through the connection of a simple, portable plug-in device. The form factor of the device may make connection more convenient, highly portable and easily detachable allowing existing HDMI signal-generating devices to be operated back in a non-wireless internet form if desired.

A connection system may be provided to allow wireless internet transmission of multiple channels of audio data without video, from existing HDMI signal-generating devices.

A connection system may be provided to allow the wireless internet reception of audio data and reproduction of that audio.

The device may be portable and easy to use and may be used in, or with, a multitude of HDMI signal-generating devices

The device and/or system may use the same connection system to support multiple audio sources both internally and externally generated, which are played back from the HDMI signal-generating device.

The device and/or system may permit low delay transmission of audio to avoid lip-sync delay.

According to a further aspect, which may be provided independently, there is provided a wireless internet audio system, for example an 802.11 wireless internet audio system, for the configuration of a wireless network and wireless internet transmission and reception of audio signals from signal-generating devices, for example HDMI signal-generating devices, to sound generating devices. The system may comprises a transmitter device, which may comprise a connector, for example an HDMI jack plug or a jack socket, in communication with a Media Access Controller and wireless internet transmitter or transceiver system and connectable to the HDMI jack plug or a jack socket or other connector of an HDMI audio signal-generating device. The system may comprise a receiver device comprising a Media Access Controller and wireless internet receiver or transceiver system. The receiver device may comprise, or form part of, or be configured to be connected to the sound generating device.

The transmitter device may comprise an HDMI transceiver, a baseband processor and a wireless internet radio.

The HDMI signal-generating device may be a personal computer, a television set, a cable or satellite set top box, a MP3 docking station, a mobile telephone, a video games system or a DVD player.

The receiver device may comprise an HDMI transceiver, a baseband processor and a wireless internet radio.

The receiver device may further comprise an audio codec.

The receiver device may further comprise an amplifier, for example a headphone or speaker amplifier.

The receiver device may be included in or connected to, for example embedded within the body of, a speaker, headphone or amplifier.

The transmitter device may transmit, and the receiver data may receive, data that is sent and/or represented using UDP or TCP protocols.

The wireless internet system may be configured such that data can be received by multiple receiver devices from one transmitter device.

Wired Equivalent Privacy (WEP) or Wi-Fi Protected Access (WPA) may be used to prevent unauthorised access.

The transmitter device and/or receiver device(s) may incorporate an electrical switch to power the device on or off.

The transmitter device and/or the receiver device may incorporate an electrical circuit to configure the device into transmit or receive mode.

The transmitter device and/or receiver device may further incorporate a circuit or system to process S/PDIF audio.

The transmitter device and/or the receiver device may further incorporate an electrical circuit and/or a software program to configure the device as a member of a wireless network.

The transmitter device and/or the receiver device may further incorporate a battery or wired power supply.

At least some components, optionally all components except the HDMI connector jack plug or HDMI connector jack socket, of the transmitter device and/or of the receiver device may be integrated into a respective single integrated circuit.

The transmitter device and/or the receiver device may further incorporate a USB charging system.

The or an audio signal may be sampled at a rate of at least 44.1 kHz.

The transmitter device and/or the receiver device may further incorporate a microprocessor to configure and control the wireless internet transceiver system.

The transmitter device may comprise an HDMI receiver device rather than a HDMI transceiver device.

The transmitter device may comprise a microprocessor or digital circuit configured to obtain a separate digital audio signal from the HDMI signal.

The transmitter device may be configured to receive audio, video or control data.

The system, for example the transmitter device and/or the receiver device, may be configured to transmit and/or receive HDMI-CEC control data.

The receiver device may be configured to apply audio effects, for example delay and/or filtering.

The transmitter device and/or the receiver device may be configured to employ software audio error correction such as finite impulse response (FIR) or fast Fourier transform (FFT).

The transmitter device may be connected to, configured to be connected to and/or compatible with HDMI ARC (Audio Return Channel) or HDMI eARC.

The receiver device may comprise and/or be configured to use an audio buffer to compensate for network transmission issues, for example network transmission delays.

The receiver device and/or the transmitter may further incorporate a Bluetooth wireless network system and/or may be configured to transmit and/or receive data using Bluetooth.

The transmitter device may be configured to establish an 802.11 connection with an 802.11 system or device, for example a PC, smartphone or tablet device.

The HDMI signal-generating device may be capable of externally receiving and/or internally generating digital audio from multiple sources.

The 802.11 signal or other signal from the transmitter device may be relayed and/or amplified via or by a device, for example a wireless networking point or signal booster for re-transmission to a receiver or receivers.

The transmitter device may be configured to take an external input HDMI signal from a physical connection, process an audio component of the HDMI signal for 802.11 transmission and relay the original HDMI signal on to another device across a physical connection.

According to embodiments, there is provided a system configured to locally source an audio stream from an HDMI device (such as a TV), for example after broadcast or other transmission and reception; establish a dedicated 802.11 network tailored for audio, use custom software and settings to encode and packetise the audio, for example with minimum latency; to recover that signal; compensate for transmission errors; and decode back into audio. Thus, a convenient low delay wire-free connection method may be provided.

Features in one aspect or embodiment may be applied as features in any other aspect or embodiment. For example, features of any one of device, system, apparatus, method or computer program product aspects or embodiments may be applied as features in any one or more other device, system, apparatus, method or computer program product aspects or embodiments.

### BRIEF DESCRIPTION OF DRAWINGS

The invention will now be described solely by way of example and with reference to the accompanying drawings in which:

FIG. 1 shows a transmitter device according to an embodiment and comprising an HDMI connector jack plug, a microprocessor and a wireless internet transceiver system and a receiver device comprising a wireless internet transceiver system, and an audio convertor connected to a speaker;

FIG. 2 shows a further embodiment of the device including a transmitter unit powered by a USB connection and a receiver powered by a battery;

FIG. 3 shows a transmitter device for connection to a television, according to an embodiment, configured to transmit the television's output audio signal to receiver devices for connection to speakers and headphones;

FIG. 4 is a schematic illustration of use of a device according to an embodiment;

FIG. 5 is a schematic illustration of operation of a transmitter device 62 connected to a television, according to an embodiment; and

FIG. 6 is a schematic illustration of a further embodiment.

### DETAILED DESCRIPTION

In this document, the following terms are used:

“audio convertor”, which may be an electronic circuit, typically in the form of an integrated circuit (IC) capable of converting analog or digital audio into electrical signals, examples include audio codec, audio digital signal processors and audio amplifiers;

“audio codec”, which may comprise an electronic circuit, typically in the form of an integrated circuit (IC) comprising an analogue-to-digital convertor (ADC) and a digital to analogue converter (DAC);

“Transceiver” which may mean a device capable of both transmitting and receiving;

“wi-fi”, “Wi-Fi” and “Wireless Internet” which may comprise the 802.11 Wireless Internet protocol.

“WLAN”, which may comprise a wireless network based on 802.11 protocols.

“Wi-Fi Transceiver”, which may comprise an electronic circuit, typically in the form of an integrated circuit (I/O) capable of sending and receiving 802.11 Wi-Fi data comprising a Wi-Fi MAC and Baseband and,

“HDMI” means High-Definition Multimedia Interface, a proprietary audio/video interface for transmitting, for example, uncompressed video data and compressed or uncompressed digital audio data from an HDMI-compliant source device, such as a display controller, to a compatible computer monitor, video projector, digital television, or digital audio device.

“HDMI Transceiver”, which may comprise an electronic circuit, typically in the form of an integrated circuit (IC) capable of sending, receiving and decoding HDMI digital audio and video data.

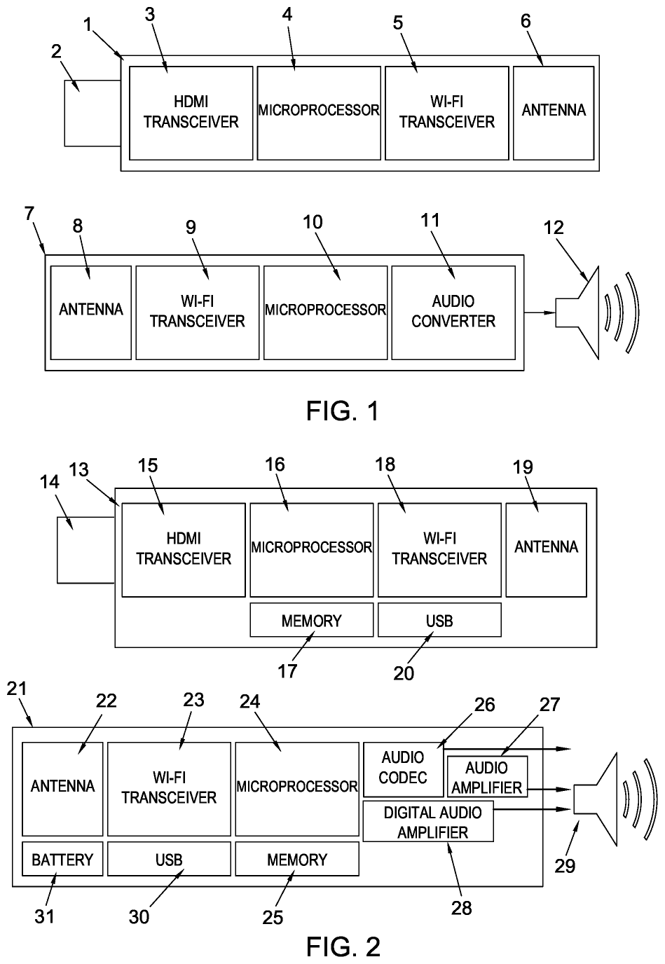

FIG. 1 is a schematic illustration of a device 1 according to an embodiment, together with a receiver device 7 according to an embodiment that is configured to receive data from the device 1.

The device 1 comprises an HDMI connector jack plug 2, an HDMI transceiver 3, a microprocessor 4, a Wi-Fi transceiver 5 and an antenna 6. The device is connectable to any suitable source of audio or audio-visual data, for example any suitable device that can provide HDMI data as an output to the connector jack plug 2 or other connector. In alternative embodiments, any suitable connector can be used in place of a jack plug. The HDMI transceiver 3 and the microprocessor 4 provide processing circuitry that also includes or is connected to the Wi-Fi transceiver 5.

The receiver device 7 comprises an antenna 8, a Wi-Fi transceiver 9, a microprocessor 10, and an audio convertor 11. The receiver device is connected to, or is configured to connect to, or further comprises, a speaker 12. The receiver device may, for example, comprise or form part of any suitable wireless headphone(s) or speaker device.

In FIG. 1, in the transmitter device 1 the HDMI connector jack plug 2 is connected to the HDMI transceiver 3. In operation the HMDI transceiver 3 decodes a digital data stream received via the connector jack plug 2 and isolates the digital audio stream that is included in the digital data stream, for processing by software within the microprocessor 4, for conversion into digital audio data. At this point the digital data is passed to the Wi-Fi transceiver 5, to format the digital signal into WLAN packets and to manage the connection and control of the wireless network. This digital data is passed to the antenna 6 for transmission. Any suitable formatting, packetisation and transmission techniques may be used in accordance with wireless protocols. For example, the packets may comprises packets according to UDP or TCP protocol.

In the receiver device 7, the signal is received by the antenna 8 and passed to the Wi-Fi transceiver 9, which decodes the signal into digital data. The digital audio data is then processed and converted within the microprocessor 10, and passed to the audio convertor 11, for output to the speaker 12.

FIG. 2 is a schematic illustration of a device 13 according to an embodiment, together with a receiver device 21 according to an embodiment that is configured to receive data from the device 1.

The device 13 comprises an HDMI connector jack plug 14, an HDMI transceiver 15, a microprocessor 16, a Wi-Fi transceiver 18 and an antenna 19. The device is connected to, connectable to, or incorporated in any suitable source of audio or audio-visual data, for example any suitable device that can provide HDMI data as an output to the connector jack plug 14. In alternative embodiments, any suitable connector can be used in place of a jack plug. The HDMI transceiver 15 and microprocessor 16 configuration may be the same as or similar to that in FIG. 1. The HDMI transceiver 15 and the microprocessor 16 provide processing circuitry that also includes or is connected to the Wi-Fi transceiver 18.

The device 13 further has computer memory 17 to store configuration and audio software for the microprocessor 16 to access. The microprocessor 16 is in connection with the Wi-Fi transceiver 18 and antenna 19 as in FIG. 1. The device 13 also has a USB input allowing power and configuration data to be supplied to the device 13.

The receiver device 21 comprises an antenna 22, a Wi-Fi transceiver 23, a microprocessor 24, an audio codec 26, an audio amplifier 27, and a digital audio amplifier 28. The receiver device 21 also comprises a memory 25, a USB connection 30 and a battery 31. The receiver device 21 is connected to, or is configured to connect to, or further comprises a speaker 12. The receiver device may, for example, comprise or form part of any suitable wireless headphone(s) or speaker device or any apparatus or system that includes a speaker.

In operation of the receiver device 21, a signal is received by the antenna 22 from device 13 and passed to the Wi-Fi transceiver 23, which decodes the signal into digital audio data. The digital audio data is then processed and converted within the microprocessor 24. The microprocessor can access configuration and software programs stored in the memory 25. The recovered digital audio data can be sent to an audio codec 26, for conversion into analog audio output from the device for processing in any suitable audio device, and/or sent to an audio amplifier 27. Alternatively or additionally the digital audio data from the processor 24 can be sent to a digital audio amplifier 28, in digital form. The amplified electrical audio signals can then be sent to a speaker 29 for conversion into sound. This embodiment is powered from a USB connection 30, which can charge an internal battery 31, although any suitable other power arrangements for the device 13 or receiver device 21 can be provided in alternative embodiments.

One example of the embodiment of the transmitter device in FIG. 2 is implemented using a Lattice Semiconductor FPGA system as the HDMI Transceiver 15, a NXP IMX6ULL microprocessor 16, a Murata LBEE5HY1MW-230 Wi-Fi Transceiver 18, and a PCB track antenna 19 in communication with a receiver device comprising a PCB track antenna 22, a Murata LBEE5HY1MW-230 Wi-Fi Transceiver 23, a NXP IMX6ULL microprocessor 24, and a Dialog DA7218 audio codec with integrated headphone driver 26 and 28. The corresponding components in the embodiment of FIG. 1 may be the same or different to those of the embodiment of FIG. 2. Any suitable alternative components may be used in other embodiments. For example, any suitable antennas, processor, receivers, transmitter or transceivers, memories, Wi-Fi, WLAN and/or networking circuitry may be used.

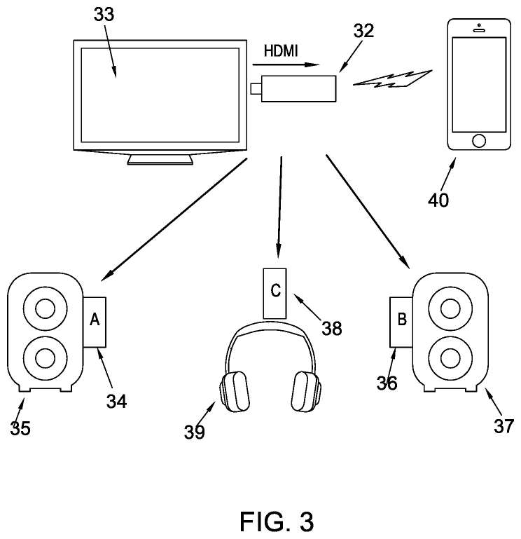

FIG. 3 illustrates schematically use of a device 32 according to an embodiment. Device 32 may be the same or similar to device 1 of FIG. 1 or device 13 of FIG. 2.

As shown in FIG. 3, transmitter device 32, is connected to the HDMI port of a HDMI signal-generating television 33, the transmitter device then establishes a network with multiple receiver devices: receiver A 34, connected to a left channel speaker 35, to receiver B 36 connected to a right channel speaker 37, and receiver C 38, connected to set of stereo headphones 39. A Wi-Fi enabled mobile telephone 40 can supply configuration and control data to the transmitter device to change the network configuration if desired, for example to establish or cease connections between the device 32 and any of receivers 34, 35, 36, 37, 38 and/or to control to which of receivers 34, 35, 36, 37, 38 audio data from device 32 is streamed.

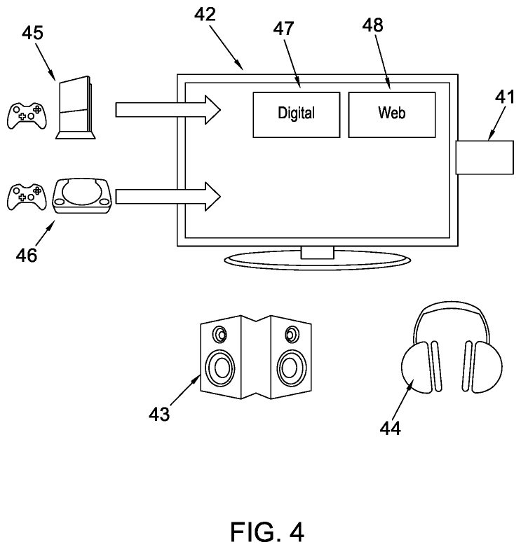

FIG. 4 illustrates schematically use of a device 41 according to an embodiment. Device 41 may be the same as or similar to device 1 of FIG. 1 or device 13 of FIG. 2. The transmitter device 41 is used in the embodiment of FIG. 4 for connection to a television, to transmit audio from one of many different input audio source signals to common receiver devices in connection to speakers and headphones.

In alternative embodiments, or alternative modes of operation, the device 1 or 13 may be connected to any suitable audio/visual device, or audio device, for example a personal computer, a television set, a cable or satellite set top box, an MP3 docking station, a mobile telephone, a video games system or a DVD player.

In FIG. 4, transmitter device 41 is connected to the HDMI port of an HDMI signal generating television 42. The transmitter device 41 then establishes a 802.11 network with multiple systems fitted with integrated receiver devices, in this example speakers 43, and headphones 44. The HDMI signal generating television, is capable of selecting between several concurrent or alternative sources of audio and video content, including external systems connected with wired HDMI, such as video games system A 45, video games system B 46, and internally generated sources such as broadcast digital television delivered via a tuner 47 and web streaming services 48. These sources can then all use the common audio network from the transmitter device 41 if desired.

Thus, for example, if a user is watching a TV programme obtained via tuner 47, the video data from the audio-visual data stream representing the TV programme is processed by the television 42 to produce video on the television screen using known techniques. An HDMI output from the television is used to output the audio-visual data as HDMI data to the transmitter device 42. Using processes as described for example in relation to FIGS. 1 to 3, the transmitter device 42 then extracts the audio data and transmits it to a selected one or more speakers 43 or headphones 44, which output the audio data to the user as sound. The user may choose to mute the television 42 itself so that sound emitted by the television 42 does not interfere with the sound output.

The processing and transmission of the audio data may be such, for example performed with sufficiently short processing and transmission time, that the video viewed on the television remains synchronised with the sound output by the speakers or headphones or other audio output device.

If the user subsequently selects to receive audio-visual data from a different device, for example to play a game using video games system A 45, then the HDMI output from the television 42 will represent the audio-visual data from the video games system A 45. The transmitter device 42 then extracts the audio data and transmits it to a selected one or more of speakers 43 or headphones 44, which output the audio data from the video game to the user as sound.

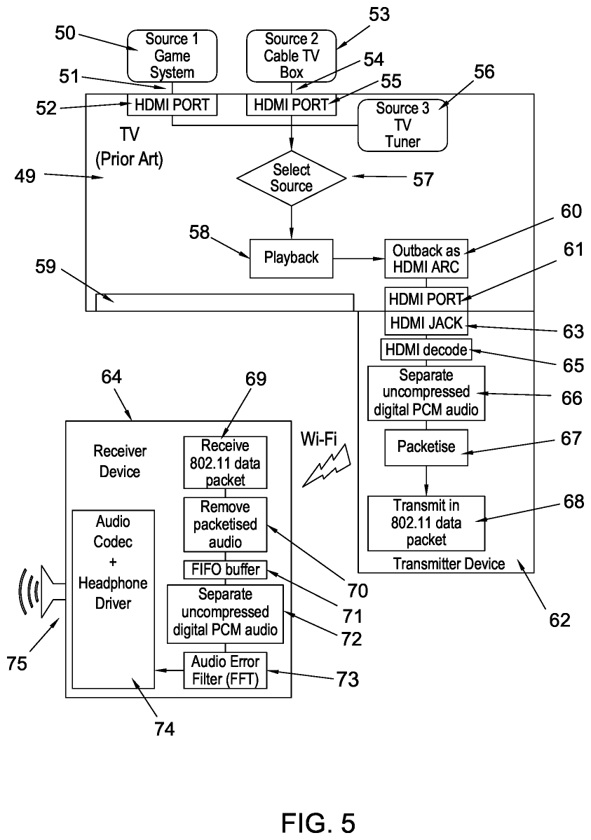

FIG. 5 is a schematic illustration of operation of a transmitter device 62 connected to a television, according to an embodiment, in which audio is transmitted from one of many different input audio source signals to a common receiver device in connection to a speaker. FIG. 5 shows both components of the transmitter device and other devices, and flow charts illustrating sequences of actions performed by the devices or their components. Device 62 may be the same as or similar to device 1 of FIG. 1 or device 13 of FIG. 2.

In the embodiment of FIG. 5, a HDMI signal generating television 49 receives a HDMI signal from source 1, in this embodiment a video game system 50, connected by a HDMI cable 51 to the HDMI port of the television 52. The television 49 also receives a HDMI signal from source 2 a video game system 53, connected by a HDMI cable 54 to the HDMI port 55 of the television. A third source internal to the television is a digital tuner 56. The user can select one or more of the sources by commanding an internal microprocessor to select and decode one of these signals 57, for playback through a media processor 58, for display on a screen 59. The media processor 58 further provides an HDMI output of HDMI ARC 60, for physical output from an HDMI port 61.

The transmitter device 62, is physically connected via an HDMI Jack 63 to the TV HDMI port 61. A wi-fi transceiver of the transmitter device 62 has negotiated and established a Wi-Fi connection with a receiver device 64. In the transmitter device the HDMI transceiver correctly identifies the HDMI audio format in use at stage 65, and separates out digital PCM audio at stage 66. The microprocessor in the transmitter splits this digital audio data into packets at stage 67, which are added into the correct 802.11 Wi-Fi format for transmission at stage 68.

The receiver device 64 receives and decodes the wi-fi packet at stage 69, and the microprocessor extracts the packetized digital audio at stage 70. This audio data is stored in a First-in-first-out buffer 71 to compensate for any transmission issues. The microprocessor takes the buffered data and reconstitutes into digital audio at stage 72. The audio signal is transformed using a Fast Fourier Transform to extract phase and frequency data at stage 73. If a packet is delayed and isn't available to be played at the time that it needs to be played, this data is used to construct a replacement packet. This now error corrected digital audio data can be sent to an audio codec 74, where it can be electrically converted and amplified, driving the speaker in a headphone 75.

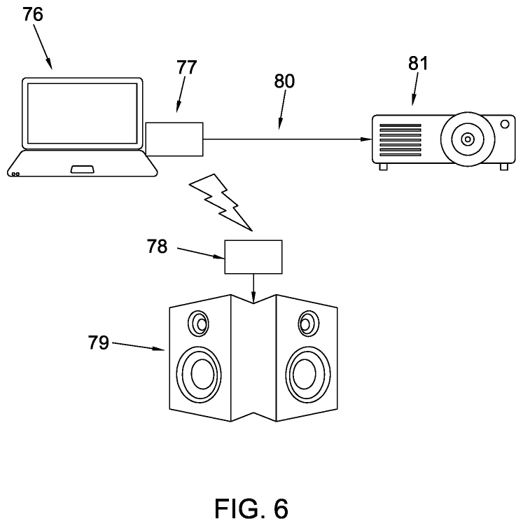

FIG. 6 shows one embodiment of a transmitter device 77 in connection to a HDMI generating laptop, wirelessly transmitting audio to a receiver device connected to speakers, while physically allowing the HDMI signal to continue on by cable to a non-audio enabled video system, a projector. Device 77 may be the same as or similar to device 1 of FIG. 1 or device 13 of FIG. 2.

In the embodiment of FIG. 6, a HDMI signal generating laptop 76, outputs a HDMI signal into the transmitter device 77, the transmitter device establishes a Wi-Fi connection with the receiver device 78, which is in turn connected to audio speakers 79. The transmitter device takes the HDMI signal, extracts the audio component and wirelessly transmits the audio to the receiver for playback through the speakers. The transmitter device is further connected to an HMDI cable 80, and the unmodified HDMI signal is sent to a non-audio capable projector 81 or other device for video playback.

HDMI is an evolving standard managed by the HDMI Forum at time of writing the latest specification HDMI 2.1 was released on Nov. 28, 2017.

HDMI devices generally support stereo (uncompressed) digital PCM audio, and alongside this audio other formats are optional, with HDMI allowing up to 8 channels of uncompressed audio at sample sizes of 16 bits, 20 bits, or 24 bits, with sample rates of 32 kHz, 44.1 kHz, 48 kHz, 88.2 kHz, 96 kHz, 176.4 kHz, or 192 kHz and an IEC 61937-compliant compressed audio stream, such as Dolby Digital and DTS, and up to 8 channels of one-bit DSD audio. With version 1.3, HDMI allows lossless compressed audio streams Dolby TrueHD and DTS-HD Master Audio. Audio return channel (ARC) is a feature introduced in the HDMI 1.4 standard. Introduced in HDMI 1.4, HDMI Ethernet and Audio Return Channel (HEAC) adds a high-speed bidirectional data communication link (HEC) and the ability to send audio data upstream to the source device (ARC) If only ARC transmission is required, a single mode signal using the HEAC+ line can be used, otherwise, HEC is transmitted as a differential signal over the pair of lines, and ARC as a common mode component of the pair.

Devices according to embodiments may be configured to identify which of the audio formats is in use and process them accordingly, allowing greater flexibility in use cases. For example, the processor of the transmitter device may be configured to determine automatically the data format of the received digital data stream and to process the digital data stream accordingly.

HDMI compatible systems such as TVs can use any of a number of wired methods to output audio. HDMI eARC transmits a high bitrate audio signal from the television to the audio device using an HDMI with Ethernet cable. TOSLINK provides fibre-optic output and HDMI ARC provides audio out over HDMI, however there is no method for the wireless streaming of realtime audio over Wi-Fi.

Embodiments can remove the messy and complex need for long physical wires.

HDMI systems such as TVs can have a multitude of audio sources, including internal sources, such as digital-free-to-air tuners, web streaming such as YouTube, Netflix and Amazon, and external sources such as games consoles, DVD players, satellite and cable boxes and internet devices such as Amazon Firestick and PC. Some sources such as games consoles further have the ability to offer non-WiFi wireless audio streaming to headphones, but specific to that source.

The ability of embodiments to provide wireless connection to the HDMI system of the TV will allow all these sources to use a common platform, meaning the user can change source without changing their headphones or speaker combination.

802.11 is a packetized transmission system, designed to carry multiple forms of data including video, documents, files etc.

802.11 Wi-Fi standards are created and maintained by the Institute of Electrical and Electronics Engineers (IEEE) LAN/MAN Standards Committee (IEEE 802). The base version of the standard was released in 1997 and has had subsequent amendments with IEEE 802.11be currently referred to as Wi-Fi 7 being the most recent version in development.

Any suitable HDMI data can be used in certain embodiments, for example any one or more of HDMI version 1.0, version 1.1, version 1.2, version 1.3, version 1.4, version 2.0, version 2.1 data and any other past, present or future version of HDMI.

Any suitable IEEE 802.11 protocol or data, or other suitable wireless protocol or data, may be used in certain embodiments, for example any one or more of 802.11, 802.11-1997, 802.11a, 802.11b, 802.11g, 802.11-2007, 802.11n, 802.11-2012, 802.11ac, 802.11ad, 802.11af, 802.11-2016, 802.11ah, 802.11ai, 802.11aj, 802.11aq, 802.11-2020, 802.11ax, 802.11ay or any other past, present or future version of 802.11.

In embodiments, switches or other user interface components may be provided on transmitter device or receiver device, as well as or instead of a user being able to control or otherwise interact with the devices via a mobile phone or other wireless connection. Further circuitries may also be included to provide desired functionality.

For example, in some embodiments the receiver device and/or the transmitter device may include an electrical switch to power the device on or off; and/or an electrical circuit to configure the device into transmit or receive mode; and/or a circuit or system to process S/PDIF audio; and/or an electrical circuit and/or a software program to configure the device as a member of a wireless network; and/or battery or wired power supply.

In some embodiments, the transmitter device comprises a baseband processor and the transmitter further comprises a wireless internet radio for transmitting the digital data stream or at least a video component of the digital data stream.

In some embodiments, the transmitter device or the combination of transmitter device and receiver device may adapt an HDMI or other audio or audio/visual apparatus device to provide audio via Wi-Fi thus potentially making the HDMI apparatus compatible with a range of Wi-Fi compatible headphones, speakers or other audio output devices.

In some embodiments, the receiver device is configured to extract data from an audio channel and to allow multiple channels of audio to be sent over a link, for example the or a wireless internet connection(s), in real time in lower bandwidth. Low delay audio may be sent to individual receivers.

In various embodiments, circuitries may be implemented as one or more ASICs (application specific integrated circuits) or FPGAs (field programmable gate arrays) or as dedicated or general purpose circuitries as appropriate.

Whilst particular circuitries or other components have been described herein, in alternative embodiments functionality of one or more of these circuitries or components can be provided by a single circuitry or other component, or functionality provided by a single circuitry or component can be provided by two or more circuitries or other components in combination. Reference to a single circuitry or component encompasses multiple circuitries or components providing the functionality of that circuitry or component, whether or not such components or circuitries are remote from one another, and reference to multiple circuitries or components encompasses a single component providing the functionality of those circuitries.

Embodiments have been described purely by way of example, and variations of detail may be provided whilst remaining within the scope of the invention.

1. A transmitter device comprising:
a connector configured to connect to an audio or audio/visual device;
processing circuitry configured to receive an HDMI digital data stream from the audio or audio/visual device and obtain a digital audio stream from the digital data stream;
a transmitter arrangement configured to transmit wirelessly the digital audio stream as Wi-Fi packets and/or wireless internet data to a receiver device for output of sound.

2. A transmitter device according to claim 1, wherein the device is configured to transmit the digital audio stream so as to provide for simultaneous output of the transmitted audio stream as sound and output of corresponding video of the digital data stream by the audio or audio/visual device.

3. A transmitter device according to claim 1, wherein:
the connector comprises an HDMI jack plug or jack socket;
the audio or audio/visual device comprises an HDMI signal generating device;
the transmitter arrangement comprises or forms part of a wireless internet transceiver system;
the processing circuitry comprises a Media Access Controller.

4. A transmitter device according to claim 1, wherein the packets and/or wireless internet data comprise data according to an 802.11 protocol, for example any one of an 802.11-1997, 802.11a, 802.11b, 802.11g, 802.11-2007, 802.11n, 802.11-2012, 802.11ac, 802.11ad, 802.11af, 802.11-2016, 802.11ah, 802.11ai, 802.11aj, 802.11aq, 802.11-2020, 802.11ax, 802.11 ay protocol or any other 802.11 protocol.

5. (canceled)

6. A transmitter device according to claim 1, configured to establish a wireless network with a plurality of receiver devices, and to transmit the digital audio stream to a selected at least one of the devices.

7. A transmitter device according to claim 1, wherein the audio or audio/visual device comprises at least one of personal computer, a television set, a cable or satellite set top box, a MP3 docking station, a mobile telephone, a video games system or a DVD player, or a device connected thereto.

8. A transmitter device according to claim 1,
wherein the transmitter device is further configured to transmit the digital data stream, or at least a video component of the digital data stream, to a further receiver device for output of video; and/or
the transmitter device is further configured to relay the original data stream to another device via physical and/or wired connection and/or via a wireless connection.

9. A transmitter device according to claim 1, wherein the processing circuitry comprises a baseband processor and the transmitter further comprises a wireless internet radio for transmitting the digital data stream or at least a video component of the digital data stream.

10. A transmitter device according to claim 1, wherein the device comprises at least one of:
a) an electrical switch to power the device on or off; or
b) an electrical circuit to configure the device into transmit or receive mode; or
c) a circuit or system to process S/PDIF audio; or
d) an electrical circuit and/or a software program to configure the device as a member of a wireless network; or
e) a battery or wired power supply.

11. A transmitter device according to claim 1, configured to receive configuration and/or control data from a mobile telephone or other remote device, and/or from a user.

12. A transmitter device according to claim 11, configured to, in response to the configuration and/or control data, establish a wireless network, and/or change network configuration, and/or establish or cease connection between the device and the or a receiver device, and/or control to which receiver device audio data is transmitted.

13. A transmitter device according to claim 1, configured to apply audio error correction to the audio data, optionally software audio error correction using finite impulse response (FIR) or fast Fourier transform (FFT) techniques.

14. A receiver device configured to receive digital audio data from a transmitter device according to claim 1, and comprising:
a receiver arrangement for receiving Wi-Fi packets and/or wireless internet data; and
processing circuitry configured to obtain digital audio data from the Wi-Fi packets and/or wireless internet data, for providing to a speaker device to generate sound.

15. A receiver device according to claim 14, wherein the receiver arrangement comprises a wireless internet transceiver and the processing circuitry comprises a Media Access Controller.

16. A receiver device according to claim 14, wherein at least one of:
a) the processing circuitry comprises a baseband processor and the receiver device comprises a wireless internet radio; or
b) the receiver device further comprises an audio codec;
c) the receiver device further comprises, or is connectable to, an amplifier, for example a headphone or speaker amplifier;
d) the receiver device is included in, connected to, or connectable to a speaker, headphone or amplifier.

17. A receiver device according to claim 14, further comprising a buffer for received audio data.

18. A receiver device according to claim 14, wherein the device comprises at least one of:
a) an electrical switch to power the device on or off; or
b) an electrical circuit to configure the device into transmit or receive mode; or
c) a circuit or system to process S/PDIF audio; or
d) an electrical circuit and/or a software program to configure the device as a member of a wireless network; or
e) a battery or wired power supply.

19. A receiver device according to claim 14, configured to receive configuration and/or control data from a mobile telephone or other remote device, and/or from a user.

20. A receiver device according to claim 19, configured to, in response to the configuration and/or control data, establish a wireless network, and/or change network configuration, and/or establish or cease connection between the receiver device and the or a transmitter device, and/or control from which transmitter device audio data is received.

21. A receiver device according to claim 14, wherein the processing circuitry is configured to apply a delay to the received data or to filter the received data.

22. (canceled)

23. A system according to claim 22, wherein the receiver device and/or the transmitter further incorporates a Bluetooth wireless network system to enable communication via Bluetooth between the receiver device and/or the transmitter device and/or at least one further device.

24. A system according to claim 22, further comprising the audio or audio/visual device wherein the audio or audio/visual device is capable of externally receiving and/or internally generating the digital data stream, and/or is configured to obtain the digital data stream from any one of a plurality of sources.

25. A system according to claim 22, further comprising a wireless networking point, a signal booster or other device configured to relay and/or amplify the digital audio stream from the transmitter device for onward transmission to the receiver device.

26. A method of providing audio data to a remote device comprising:
extracting digital audio data from an HDMI digital data stream from an audio or audio/visual device and transmitting wirelessly the digital audio data as Wi-Fi packets and/or wireless internet data to the remote device for output of sound.

27. A transmitter device according to claim 1, wherein the packets and/or wireless internet data are transmitted using UDP or TCP protocol.
